(19) United States
(12) Patent Application Publication
(10) Pub. No.: US 2007/0182344 A1
(43) Pub. Date: Aug. 9, 2007

(54) Lamp driver providing synchronization during commutation

(75) Inventors: Lambertus Henricus Cornelis De Brouwer, Eindhoven (NL); Patrick John Zijlstra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,230

(22) PCT Filed: Jul. 8, 2005
(86) PCT No.: PCT/IB05/52278

§ 371 Date: Jan. 17, 2007

(30) Foreign Application Priority Data
Jul. 21, 2004 (EP) 04103489.3

(51) Int. Cl. H05B 41/36

(52) U.S. Cl. 315/291

(57) ABSTRACT

A lamp driver having two independently operating half-bridges integrated as a down-converter (1) and one as an alternator (2). Ensures that current control and inversion can be performed in a single stage, thereby providing synchronization at commutation moment. May comprise detection means (15, 18) for detecting a defined state of the down-converter (1), in which case commutation is only carried out if it has been requested and the defined state has been detected. A delay circuit (16) may ensure that commutation is always carried out if requested, even if the defined state is not detected.

### FIELD OF THE INVENTION

The present invention relates to a lamp driver, in particular for a projection display device. More particularly, the present invention relates to a lamp driver having two independently operating half-bridges, the lamp driver being adapted to provide synchronization of commutation.

### BACKGROUND OF THE INVENTION

Prior art lamp drivers typically comprise one half-bridge which operates as an alternator, while the current control is performed by a down-converter connected in front of it. Such a lamp driver is, e.g., disclosed in U.S. Pat. No. 5,828,187. A disadvantage of these prior art lamp drivers is that the down-converter and the alternator are not synchronized at commutation moment. As a consequence, optimal overshoot compensation is not possible, high peak currents may appear in switching devices during commutation, high electromagnetic interference (EMI) may occur due to hard switching, and/or high switching losses may occur during commutation.

### SUMMARY OF THE INVENTION

It is an object of the present invention to provide a lamp driver in which it is possible to provide synchronization between the down-converter and the alternator at commutation moment, thereby enabling optimal overshoot compensation.

According to a first aspect of the present invention the above and other objects are obtained by providing a lamp driver comprising at least two independently operating half-bridges integrated therein, wherein:
a first of said half-bridges operates as a down-converter, thereby determining the output current of the lamp driver, and
a second of said half-bridges operates as an alternator, thereby ensuring that the output current of the lamp driver is an AC current.

The fact that the first and second half-bridges are both integrated into the lamp driver ensures that current control and inversion can be performed in a single stage. Thereby the down-converter and the alternator can be synchronized at commutation moment. This is very advantageous since it allows for optimal overshoot compensation, lower peak currents through switching devices during commutation, reduction of electromagnetic interference (EMI), lower switching losses during commutation, etc.

The lamp driver may further comprise means for detecting a defined state of the first half-bridge, and means for carrying out commutation in response to the detected defined state and in case commutation has been requested, thereby ensuring a commutation which is synchronized with the state of the first half-bridge.

This embodiment is very advantageous because it even further improves the synchronization during commutation.

One way of operating the lamp driver is as follows. When commutation is requested the detection means checks whether the defined state of the first half-bridge occurs. If this is the case, commutation is carried out. If it is not the case, the lamp driver waits for the defined state to occur before carrying out commutation.

The ‘defined state’ may be the moment at which the peak current through the down-converter coil has reached its minimum or maximum value. This may, e.g., be measured by means of a current sensor. Alternatively, the detection of the ‘defined state’ may be the detection that the first half-bridge is switching. In this case the current through the down-converter coil will also be at a maximum or minimum value. Or the ‘defined state’ may be the moment when the ripple voltage of the down-converter has reached a certain value, e.g. a maximum amplitude.

The means for carrying out commutation may further be adapted to carry out commutation after a predetermined time has elapsed from a request for commutation, even if the defined state of the first half-bridge has not been detected.

In some cases the defined state does not occur. This may, e.g., be the case during early run-up phase due to non-switching of the down-converter. In this case commutation is not carried out, even if it is requested. This results in hampered lamp run-up or extinguishing of the lamp. According to the embodiment described above, commutation is carried out at least after a certain time has elapsed, regardless of whether or not the defined state has been detected. Thus, commutation will always be carried out if it is requested. This results in the down-converter starting to switch again, thereby realizing smooth run-up.

The lamp driver of the present invention is particularly suitable for use in an illumination system, a luminaire and/or a display system, e.g. a projection display system. A display system comprising a lamp driver according to the present invention may advantageously be used in a direct view LCD system. However, the lamp driver may alternatively or additionally be used in any other suitable apparatus.

These and other aspects of the invention will be apparent from and elucidated with reference to the embodiments described hereinafter.

### BRIEF DESCRIPTION OF THE DRAWING

FIG. 1 shows a circuit diagram for a lamp driver according to the invention.

### DESCRIPTION OF PREFERRED EMBODIMENTS

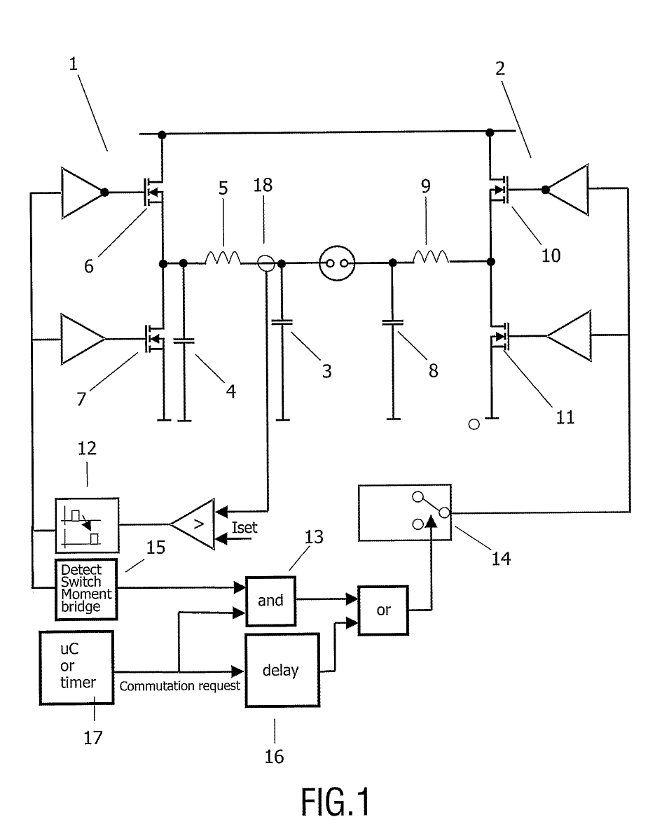

FIG. 1 shows a circuit diagram for a lamp driver according to the invention. The left side of the circuit operates as a down-converter 1 and the right side of the circuit operates as an alternator 2.

The down-converter 1 comprises a first capacitor 3, a second capacitor 4, an inductive coil 5, a first field effect transistor (FET) 6, and a second FET 7. The duty cycle of the down-converter 1 determines the output voltage, which is the voltage applied to capacitor 3.

The alternator 2 comprises a capacitor 8, an inductive coil 9, a first field effect transistor (FET) 10, and a second FET 11. When the second alternator-FET 11 is conducting, the voltage applied to the lamp is the voltage applied to capacitor 3. When, on the other hand, the first alternator-FET 10 is conducting, the lamp current changes direction, and the voltage applied to the lamp is the supply voltage minus the voltage applied to capacitor 3.

In normal operation the down-converter 1 is switching at a relatively high frequency, preferably above 100 kHz, while the alternator side 2 is commutating at relatively low frequency, preferably below 1 kHz.

The circuit diagram further comprises detection means comprising a current sensor 18 for measuring the current and enabling switching of the down-converter 1. The current sensor 18 may, e.g. be a hall sensor or a magneto-resistive current sensor. A function 17, e.g. a timer or a uController, defines the required commutation moment.

The lamp driver works in the following way. When commutation is requested by function 17 the circuit 15 checks whether or not the half-bridge of the down-converter 1 switches. This phenomenon is denoted the ‘defined state’. When the half-bridge switches, commutation is performed by 14.

The circuit diagram further comprises a delay circuit 16. When commutation is requested, the delay circuit 16 is activated. This has the effect that, in case the down-converter 1 is not switching, i.e. the defined state does not occur, commutation is performed anyway after a certain delay period has lapsed. Thereby it is ensured that commutation takes place at least within a certain time after it is requested, and it is also ensured, due to the topology properties, that the down-converter 1 starts switching again. This ensures a more smooth run-up of the lamp.

Although the present invention has been described in connection with the preferred embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “an”, “first”, “second” etc. do not preclude a plurality. Furthermore, reference signs in the claims shall not be construed as limiting the scope.

1. A lamp driver comprising at least two independently operating half-bridges integrated therein, wherein:
a first of said half-bridges operates as a down-converter (1), thereby determining the output current of the lamp driver, and
a second of said half-bridges operates as an alternator (2), thereby ensuring that the output current of the lamp driver is an AC current.

2. A lamp driver according to claim 1, further comprising
means (15, 18) for detecting a defined state of the first half-bridge, and
means (13, 14) for carrying out commutation in response to the detected defined state and in case commutation has been requested,
thereby ensuring a commutation which is synchronized with the state of the first half-bridge.

3. A lamp driver according to claim 2, wherein the means (13, 14) for carrying out commutation is further adapted to carry out commutation after a predetermined time has elapsed from a request for commutation, even if the defined state of the first half-bridge has not been detected.

4. An illumination system comprising a lamp driver according to claim 1.

5. A display system comprising a lamp driver according to claim 1.

6. A display system according to claim 5, said display system being a projection display system.

7. A direct view LCD system comprising a display system according to claim 5.

8. A luminaire comprising a lamp driver according to claim 1.

9. A method for operating a lamp driver according to claim 1, the method comprising the steps of:
detecting whether a defined state for the first half-bridge is occurring, and
carrying out commutation in case it is detected that the defined state is occurring, and in case commutation has been requested.
